(19) United States
(12) Patent Application Publication
(10) Pub. No.: US 2002/0088638 A1
(43) Pub. Date: Jul. 11, 2002

(54) Assembly for shielded terminal and method for assembling shielded terminal

(75) Inventor: Kazuhiko Nimura, Yokkaichi-city (JP)

Correspondence Address: GREENBLUM & BERNSTEIN, P.L.C., 1941 ROLAND CLARKE PLACE, RESTON, VA, 20191, US

(73) Assignee: SUMITOMO WIRING SYSTEMS, LTD., Yokkaichi-city (JP)

(21) Appl. No.: 09/989,145

(22) Filed: Nov. 21, 2001

(30) Foreign Application Priority Data
Jan. 5, 2001 (JP) 2001-000354

(51) Int. Cl. H01R 4/00

(52) U.S. Cl. 174/75 C

(57) ABSTRACT

A pair of connecting pieces which can sandwich tabs of a corresponding terminal are provided at the edges of an internal terminal, both of the connecting pieces are formed in an L-shaped cantilevered form extending from left and right side faces facing each other to a lower face portion. A dielectric is preliminarily fixed on the internal terminal, and then, an assembly is formed by connecting the core wire of a shielded electric wire with the internal terminal. This assembly is fixed in an external terminal, and then, the net braid of the shielded electric wire is connected with the external terminal. The internal terminal is protected by the dielectric during assembly of the internal terminals and the external terminal.

### BACKGROUND OF THE INVENTION

1. Field of the Invention

The present invention relates to an assembly for a shielded terminal and a method for assembling a shielded terminal.

2. Description of Background Information

A terminal which is shown in FIG. 15 has been conventionally known as a female shielded terminal. The female shielded terminal is equipped with an integral terminal 1 which is to be connected with a corresponding male terminal (not shown), and an external terminal 2 which encloses the internal terminal 1 with a dielectric 3 provided therebetween. To assemble the female shielded terminal, the internal terminal 1 is clamped around and connected with the end of a core wire 5 (inner conductor) of a shielded wire 4. A dielectric 3 is sized to fit into and to be fixed to the external terminal 2. The external terminal 2 is designed to be clamped around and connected with a net braid wire 6 (outer conductor) of a shielded wire 4 after the internal terminal 1 is inserted in the dielectric 3.

This type of shielded wire is disclosed in Japanese Patent Publication (Kokai) No. 2000-173725.

In the conventional type of terminal, an elastic connecting piece 7 is provided to be brought in contact with a corresponding male terminal. The elastic connecting piece 7 of the conventional internal terminal 1 is formed by cutting through the walls of a square pipe to the inside thereof. Since this type of terminal is required to be a small size, and in the case of a small size, there is a danger that the connecting piece 7, which was obtained by simply cutting a wall face, will be deficient in the amount of contact pressure applied to the corresponding male terminal.

Accordingly, there has been proposed a connecting piece that can apply enhanced contact pressure by forming the elastic connecting piece so as to be provided on two wall faces of a square pipe and increasing the rigidity of a fulcrum portion. However, since the terminal is constructed such that the elastic connecting piece is exposed in the front portion of the internal terminal, there is a danger that the connecting piece will be plastically deformed due to striking foreign objects or the like before the inner conductor is assembled to the outer conductor. Thus, the status quo has been maintained and such a structure has not been adopted.

### SUMMARY OF THE INVENTION

The present invention was developed based on the above-mentioned circumstances.

According to an aspect of the present invention, an assembly for a shielded terminal is provided including a dielectric that is preliminarily mounted on the outer peripheral surface of an internal terminal. The internal terminal may be provided with an elastic connecting piece that is connected with the inner conductor of a shielded electric wire and brought in contact with a corresponding male terminal. The dielectric may be provided between an external terminal that is connected with the outer conductor of the shielded electric wire and the internal terminal.

According to a further aspect of the invention, a pair of connecting pieces that can elastically sandwich a corresponding male terminal is provided on the internal terminal, and the respective elastic connecting pieces may be formed in L-shaped sections in a cantilevered form that extend from oppositely facing walls to a portion of the wall therebetween.

In another aspect of the present invention, a method of assembling a shielded terminal is provided including in that after an internal terminal which is equipped with an elastic connecting piece, which is to be brought into contact with a corresponding male terminal, is fit into and fixed in a dielectric, the inner conductor of a shielded electric wire is connected with the internal terminal, and then after the internal terminal and the dielectric are fixed in an external terminal, the outer conductor of the shielded electric wire is connected with the external terminal.

According to a further aspect of the present invention, the internal terminal is formed, the dielectric is positioned to cover the internal terminal, and therefore an assembly is formed and the assembly fixed in the external terminal. Since the internal terminal is protected by the dielectric during the assembly of the internal terminal in the external terminal, there is freedom in the design by which the elastic connecting piece is formed in an exposed form. In other words, there are fewer constraints on the design of the internal terminal since it will be protected by the dielectric.

Further, the elastic connecting pieces are supported by an L-shaped portion forming adjacent square tubes, and include two facing walls. Thus, the rigidity of the fulcrum portion is enhanced and contact pressure can be enhanced.

In a further aspect of the invention, the internal terminal is fixed in the dielectric, assembly is performed by connecting the inner conductor of a shielded electric wire with the internal terminal, the assembly is fixed in the external terminal, and then the outer conductor of a shielded electric wire is connected with the external terminal. Similarly, the internal terminal is protected by the dielectric during the assembly of the internal terminal in the external terminal.

According to a further aspect of the present invention, an assembly for a female shielded terminal is provided including an internal terminal to connect to an inner conductor of a shielded electric wire, the internal terminal including at least one elastic connecting piece to contact a corresponding male terminal, and a dielectric mounted on an outer periphery of the internal terminal to insulate the internal terminal from an external terminal connected to an outer conductor of the shielded electric wire. Further, the at least one elastic connecting piece may include a pair of elastic connecting pieces provided on the internal terminal, wherein each connecting piece of the pair of connecting pieces is configured in an L-shape extending from a respective facing wall of the internal terminal to a wall of the internal terminal provided between the facing walls and each connecting piece of the pair of connecting pieces is cantilevered from the internal terminal so that the connecting pieces can elastically sandwich the corresponding male terminal therebetween.

In a further aspect of the present invention, the internal terminal may further include a slit between the connecting pieces, and each connecting piece of the pair of connecting pieces may include a bent portion, wherein the bent portions extend toward each other. Further, the dielectric may include a hole extending from a forward end to a rearward end of the dielectric, the internal terminal being positioned inside the hole; and the hole may be dimensioned to allow movement of the connecting pieces toward and away from each other.

According to another aspect of the present invention, the internal terminal may further include a pair of thrusting pieces, the thrusting pieces projecting from opposite sides of the internal terminal, the dielectric may further include a pair of pressure grooves extending along sides of the hole to receive the thrusting pieces. Further, the shielded terminal may include an external terminal covering the dielectric and the internal terminal therein, the external terminal including holding parts positioned at a front portion of the external terminal to receive a front end of the dielectric. The dielectric may be block shaped, and the holding parts may form a square for receiving the dielectric. Further, the external terminal may include a covering wall part positioned rearward of the holding parts, the covering wall part including an open upper face to receive a rear portion of the internal terminal; and the external terminal may further include a barrel portion positioned rearward of the covering wall part, the barrel portion including an open upper face to receive a net braid shield of the shielded electric wire and including barrel portions to bend and cover the braid shield of the shielded electric wire. The external terminal may further include a lance on a lower face of the external terminal extending obliquely toward a front portion of the external terminal; and the dielectric may further include a hooking groove on a lower face of the dielectric extending from a rearward to a forward direction of the dielectric to receive the lance and secure the dielectric and the external terminal together.

In a further aspect of the present invention, a method of assembling a female shielded terminal is provided including providing an internal terminal to connect to an inner conductor of a shielded electric wire, the internal terminal including at least one elastic connecting piece to contact a corresponding male terminal, mounting a dielectric on an outer periphery of the internal terminal, after mounting the dielectric on the internal terminal, connecting the inner conductor of the shielded electric wire to the internal terminal, providing an external terminal to connect to an outer conductor of the shielded electric wire, mounting the external terminal on the dielectric and the internal terminal therein, and after mounting the external terminal on the dielectric and the internal terminal therein, connecting the external terminal to the outer conductor of the shielded electric wire.

According to a further aspect of the present invention, mounting the dielectric on the internal terminal may include covering the at least one connecting piece with the dielectric so that damage to the at least one elastic connecting piece is prevented. Further, the at least one elastic connecting piece may include a pair of elastic connecting pieces provided on the internal terminal, and each connecting piece of the pair of connecting pieces may be configured in an L-shape extending from a respective facing wall of the internal terminal to a wall of the internal terminal provided between the facing walls and each connecting piece of the pair of connecting pieces may be cantilevered from the internal terminal so that the connecting pieces can elastically sandwich the corresponding male terminal therebetween, and mounting the dielectric on the internal terminal may include covering the pair of elastic connecting pieces with the dielectric so that damage to the pair of elastic connecting pieces is prevented. Further, the dielectric may include a hole extending from a forward end to a rearward end of the dielectric, and the method may further include positioning the internal terminal inside the hole.

In a further aspect of the present invention, the internal terminal further includes a pair of thrusting pieces, the thrusting pieces projecting from opposite sides of the internal terminal, the dielectric further including a pair of pressure grooves extending along sides of the hole to receive the thrusting pieces, and the method may further include positioning the thrusting pieces inside the pressure grooves. Further, the method may further include covering the dielectric and the internal terminal therein with an external terminal, wherein the external terminal includes holding parts positioned at a front portion of the external terminal, and the covering includes receiving a front end of the dielectric with the holding parts. Further, the dielectric may be block shaped, with the holding parts forming a square for receiving the dielectric, and the method may further include receiving the dielectric with the holding parts so that a forward end of the dielectric abuts the holding parts. The external terminal may further include a covering wall part positioned rearward of the holding parts, the covering wall part including an open upper face to receive a rear portion of the internal terminal, and the method may further include receiving the rear portion of the internal terminal in the covering wall part.

In a further aspect of the present invention, the external terminal may further include a barrel portion positioned rearward of the covering wall part, the barrel portion including an open upper face to receive a net braid shield of the shielded electric wire and including barrel portions to bend and cover the braid shield of the shielded electric wire, and the method may further include receiving the net braid shield of the shielded electric wire in the barrel portion, and bending the barrel portion around the net braid shield to cover the net braid shield. Further, the external terminal may further include a lance on a lower face of the external terminal extending obliquely toward a front portion of the external terminal and the dielectric may further include a hooking groove on a lower face of the dielectric extending from a rearward to a forward direction of the dielectric to receive the lance and secure the dielectric and the external terminal together, the method further including receiving the lance in the hooking groove, thereby securing the dielectric and the external terminal together.

According to another aspect of the present invention a method of assembling a female shielded terminal is provided including providing an internal terminal to connect to an inner conductor of a shielded electric wire, the internal terminal including at least one elastic connecting piece to contact a corresponding male terminal, mounting a dielectric on an outer periphery of the internal terminal, providing an external terminal to connect to an outer conductor of the shielded electric wire, mounting the external terminal on the dielectric and the internal terminal therein, and after mounting the external terminal on the dielectric and the internal terminal therein, simultaneously connecting the inner conductor of the shielded electric wire to the internal terminal and connecting the external terminal to the outer conductor of the shielded electric wire.

### BRIEF DESCRIPTION OF THE DRAWINGS

The above and other objects, features and advantages of the present invention will be made apparent from the following description of the preferred embodiments, given as non-limiting examples, with reference to the accompanying drawings in which:

FIG. 1 is an exploded side view of a shielded terminal according to the present invention;

FIG. 2 is a partial cross-sectional plan view showing a condition before assembly of the internal terminal with the dielectric in the shielded terminal of FIG. 1;

FIG. 3 is a cross-sectional side view of a condition before assembly of the internal terminal with the dielectric of FIG. 2;

FIG. 4 is a front view of the dielectric of the shielded terminal of FIG. 1;

FIG. 5 is a rear view of the dielectric of the shielded terminal of FIG. 1;

FIG. 6 is a front view of the external terminal of the shielded terminal of FIG. 1;

FIG. 7 is a plan view of the internal terminal of the shielded terminal of FIG. 1;

FIG. 8 is a partial cross-sectional plan view of the dielectric fixed on the internal terminal in the shielded terminal of FIG. 1;

FIG. 9 is a cross-sectional side view of the dielectric fixed on the internal terminal of FIG. 8;

FIG. 10 is a partial cross-sectional plan view showing a condition before assembly of the internal terminal and dielectric with an external terminal of the shielded terminal of FIG. 1;

FIG. 11 is a cross-sectional side view of a condition before assembly of the internal terminal and the dielectric with the external terminal of FIG. 10;

FIG. 12 is a cross-sectional plan view of a condition in which an internal terminal and dielectric assembly is provided in an external terminal of the shielded terminal of FIG. 1;

FIG. 13 is a cross-sectional side view of the internal terminal and dielectric assembly provided in an external terminal of FIG. 12;

FIG. 14 is a cross-sectional side view of a condition in which the assembly of the shielded terminal of FIG. 1 is completed; and

FIG. 15 is an exploded perspective view of a conventional example of a shielded terminal.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

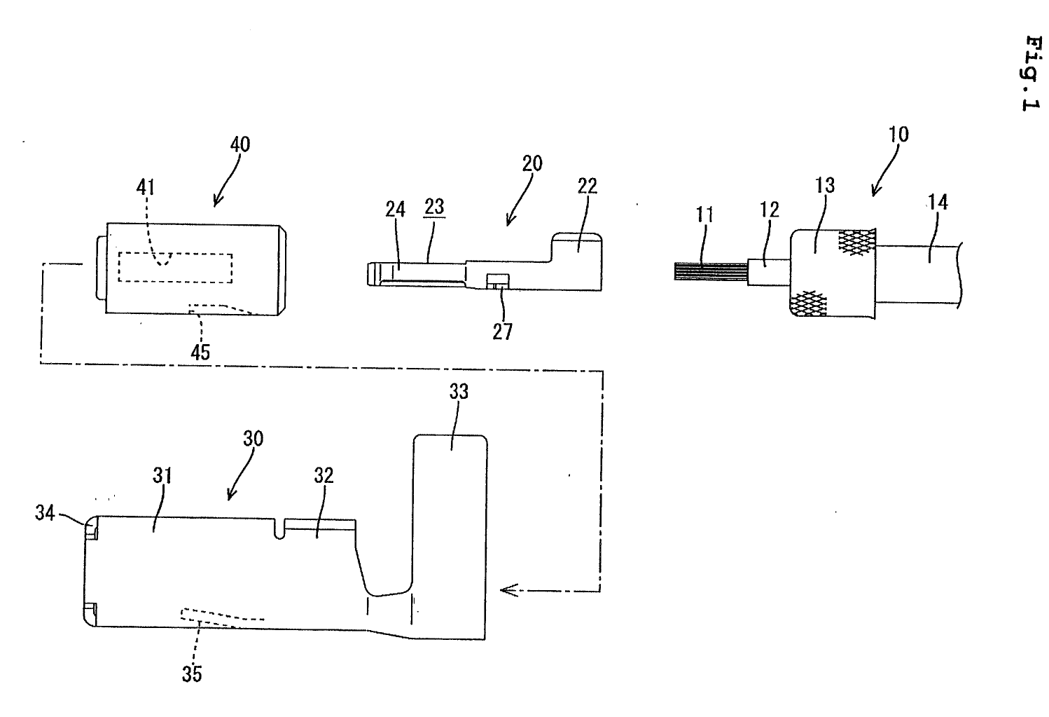

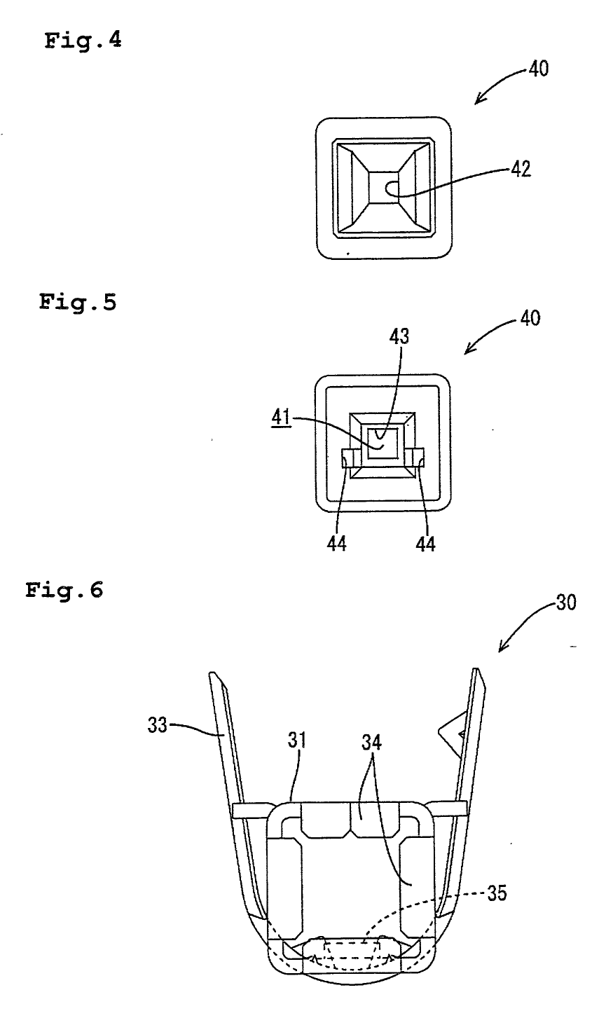

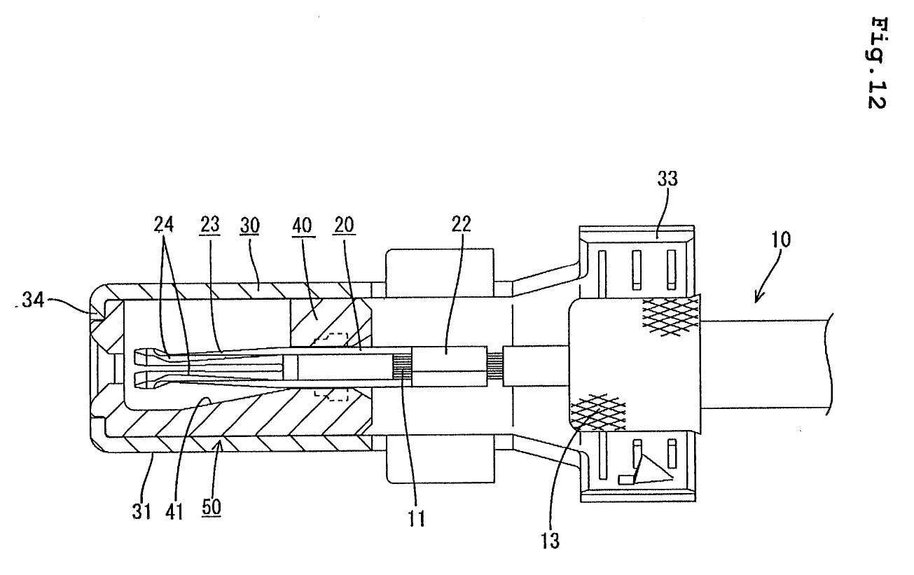

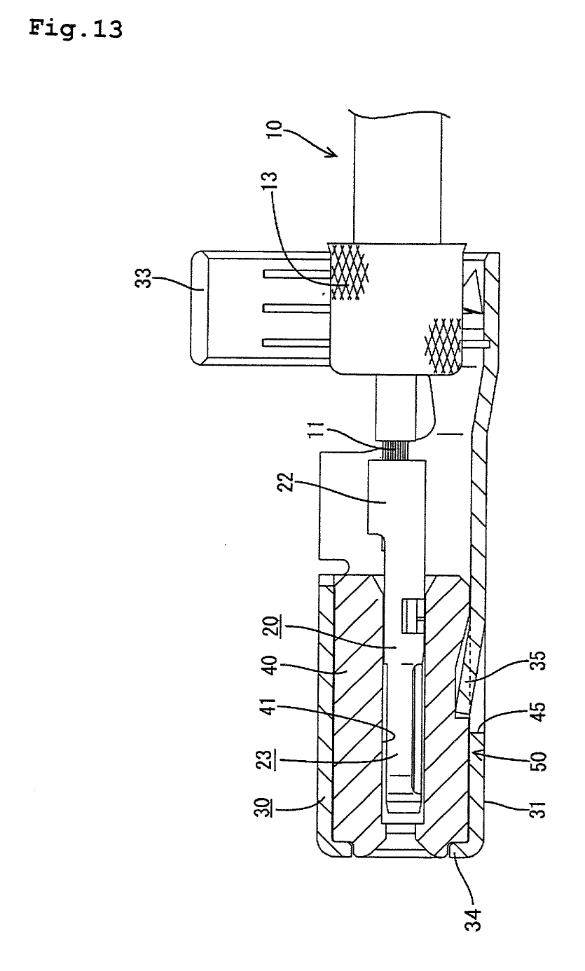

An embodiment of the present invention is illustrated in FIGS. 1-14.

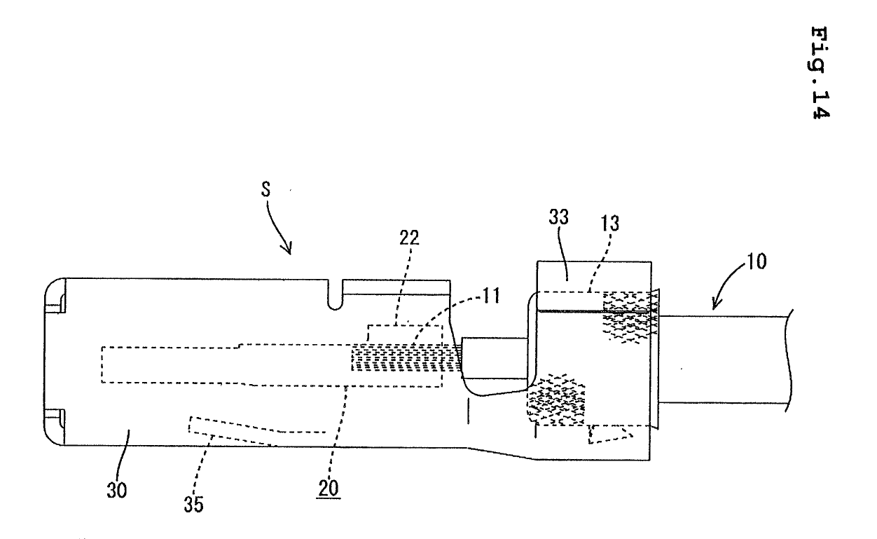

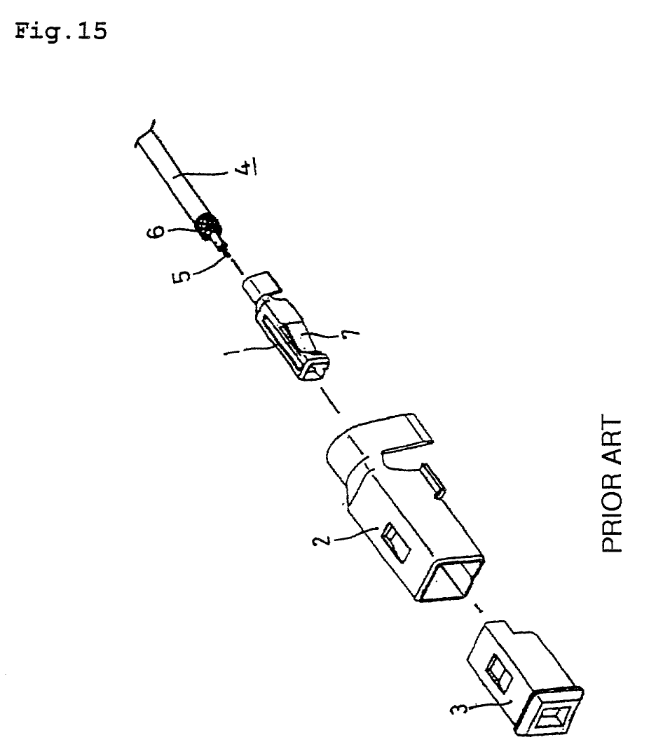

A female shielded terminal S is shown in FIG. 14 exemplified in one embodiment of the present invention. The female shielded terminal S is designed to be used by being clamped on the end of a shielded electric wire 10.

As shown in FIG. 1, the shielded electric wire 10 is known to those having skill in the art, and is a structure in which a core wire (inner conductor) 11 which is a bundle of a plurality of single wires, an insulator layer 12, a net braid wire (outer conductor) 13, and a sheath 14 made of a rubber or the like are coaxially arranged in that order from inside to outside. In the operation of the present invention, a treatment is performed in which the net braid wire 13 is obtained by stripping and exposing the end of the sheath 14 and folding the net braid wire 13 onto the sheath 14. The end of the insulator layer 12, exposed by the removal of the sheath 14 and folding over of the net braid wire 13 is then cut to expose the core wire 11.

The shielded terminal S, roughly divided, includes the internal terminal 20, the external terminal 30 and the dielectric 40 as shown in FIG. 1.

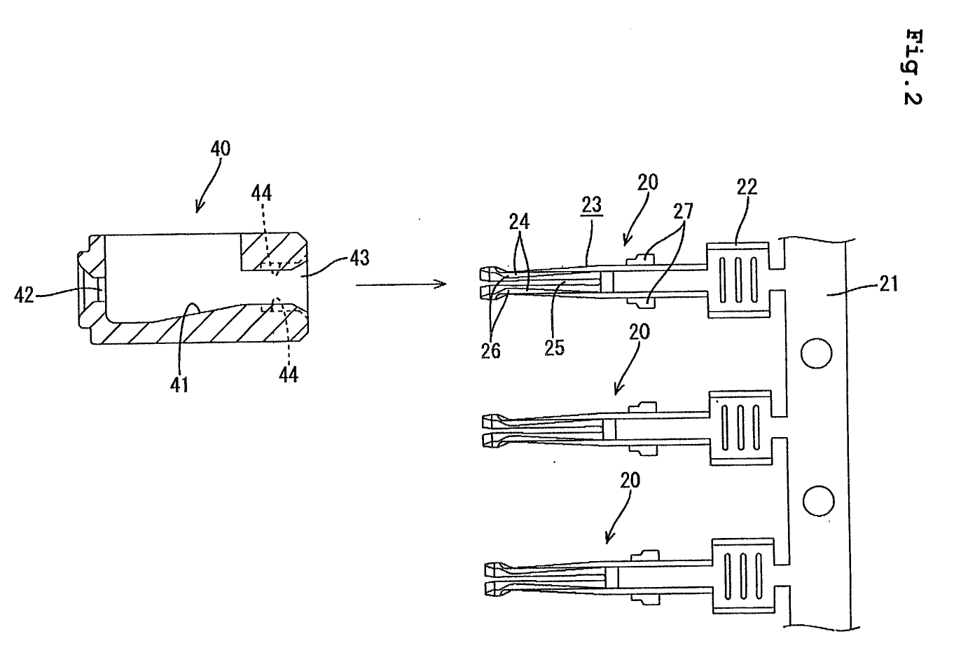

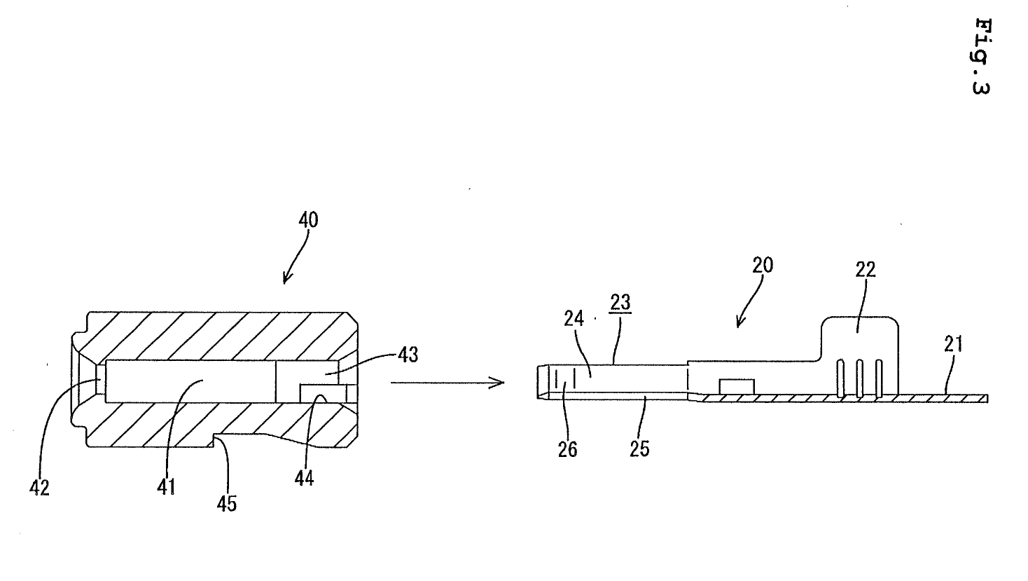

The internal terminal 20 is formed in a female terminal form by any suitable technique such as, for example, by press molding a metal plate. As shown in FIGS. 2 and 3, the internal terminal 20 may be formed as sequential and adjacent terminals which are linked by the carrier 21. The internal terminal 20 has a long narrow channel shape with an open upper face. The internal terminal 20 includes a barrel 22 for clamping the core wire 11 of the shielded electric wire 10 formed at the rear portion thereof. The barrel 22 is initially upwardly open before assembly with the core wire 11. The connecting parts 23 which are to be connected with the tabs of a corresponding male internal terminal (not illustrated) are provided at the edges of the internal terminal 20. In particular, a pair of connecting pieces 24 is provided at the connecting parts 23, both of the connecting pieces 24 are formed in a generally L-shaped cross-section which extends from the left and right side faces, respectively, to the portion of the lower face by cutting the vertical slit 25 at the lower face. The connecting pieces are in a cantilever form which faces in a forward direction toward the front portion of the inner terminal 20 and are arranged facing each other. As best shown in FIG. 2, the side face portions on the edge of both of the connecting pieces 24 are bent toward the center and each other to form the contact parts 26. The contact parts 26 may be elastically deformed in the approaching and exiting directions of the male internal terminal and can sandwich the tabs of the corresponding male internal.

Thrusting pieces 27 are formed to project from the lower positions of both the left and right faces at the rear portion of the connecting parts 23.

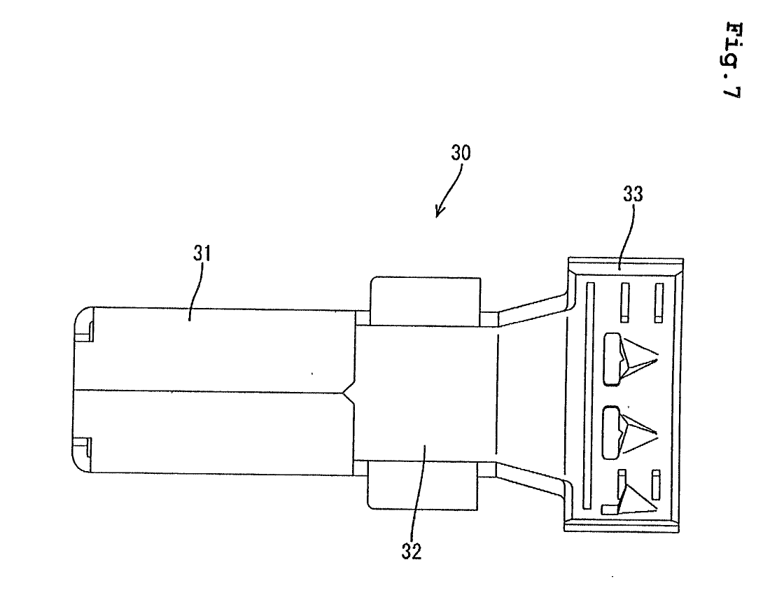

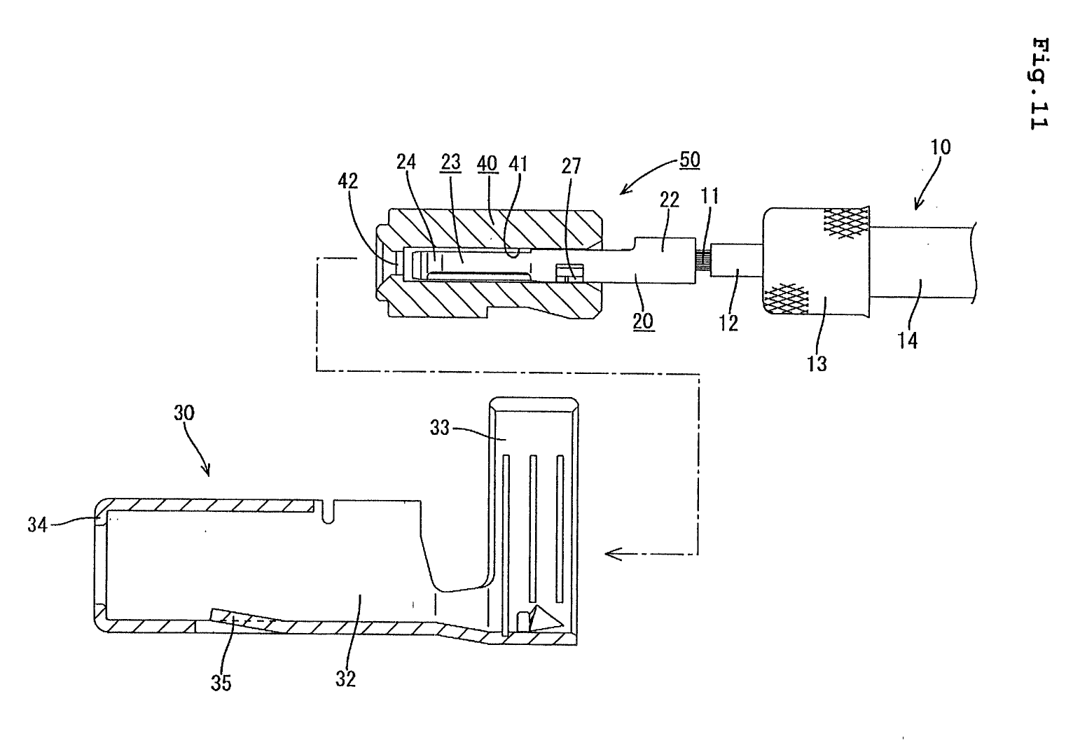

The external terminal 30 is formed by any suitable technique such as, for example, by press molding a metal plate, and as shown in FIGS. 6 and 7, the holding parts 31, which are formed in the shape of a square pipe, the covering wall part 32 having an open upper face, and the barrel 33 for clamping the net braid wire 13 that was folded over the sheath 14 in the shielded electric wire 10 are formed in that order from left to right as shown in FIG. 7. Similarly, the barrel 33 is open at the beginning of the operation, prior to assembly as the female internal terminal S. The front stopping pieces 34 against which the front face of the dielectric 40 abuts are formed at the front rim of the holding parts 31. At the lower face of the holding parts 31 is provided a metal lance 35 (refer to FIG. 11) which hooks the dielectric 40 in a condition in which slip of the dielectric is stopped and prevented. The metal lance 35 is formed in a position which faces obliquely forward and is cut to extend inside the holding parts 31.

The dielectric 40 may be formed of any suitable insulating material such as, for example, a synthetic resin or the like. The dielectric 40 functions to electrically insulate the internal terminal 20 from the external terminal 30. The dielectric 40 may be formed in a block form which can be positioned in the holding part 31 of the external terminal 30. The internal terminal 20 can be inserted into the insertion hole 41. The insertion hole 41 faces in the forward and rearward direction and is formed on the inside of the dielectric 40. As shown in FIG. 3, the height (in the direction transverse to the arrow in FIG. 3) of the insertion hole 41 is approximately the same dimension as the height of the connecting parts 23 of the internal terminal 20. However, to the contrary, as shown in FIG. 2, the width of the insertion hole 41 (the dimension in side to side or the left and right direction of the assembly) toward the edge side is wide so as to allow the bending deformation of the connecting pieces 24 away from each other. The tabs of a male internal terminal can be inserted at the front face opening 42 of the installation hole 41, and the pressuring grooves 44 into which each thrusting piece 27 of the internal terminal 20 can be pressed and inserted are formed at the left and right face of the rear opening 43.

Further, as shown in FIG. 3, the hooking groove 45, with which the metal lance 35 of the external terminal 30 cooperates and fits into, is formed at the lower face of the dielectric 40.

The operation of the above-noted embodiment of the present invention will now be described. The operation of mounting the shielded terminal S at the end of the shielded electric wire 10 is performed by the procedure below. The treatment of the shielded electric wire 10 is performed as described above.

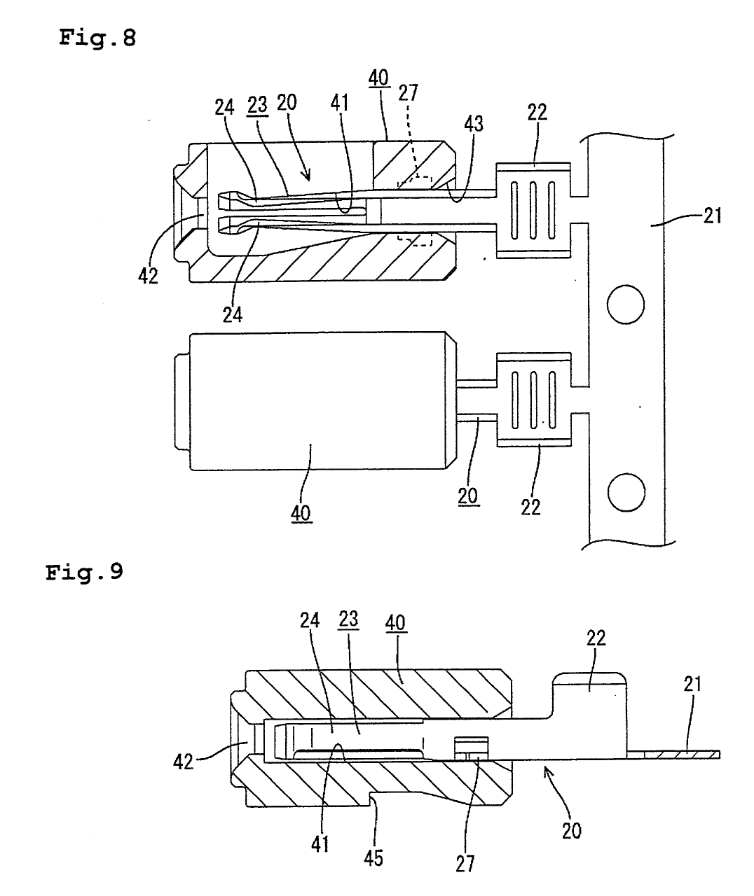

As shown in FIGS. 2 and 3, the internal terminal 20 is formed or molded to be linked with the carrier 21, and delivered to a fixed assembly position of the dielectric. As shown by the arrows of FIGS. 2 and 3, the dielectric 40, which was separately prepared, is pushed in toward the internal terminal 20 at the assembly position. The internal terminal 20 and the dielectric 40 are moved relative to each other and the internal terminal 20 is inserted into the installation hole 41 of the dielectric 40 from the rear end thereof, and as shown in FIGS. 8 and 9, when the forward edge of the internal terminal 20 is inserted to a position adjacent the front face opening 42 of the installation hole 41, the thrusting pieces 27 thrust into the pressure grooves 44, creating a condition in which the dielectric 40 is integrally fit onto and fixed at the outer periphery of the internal terminal 20.

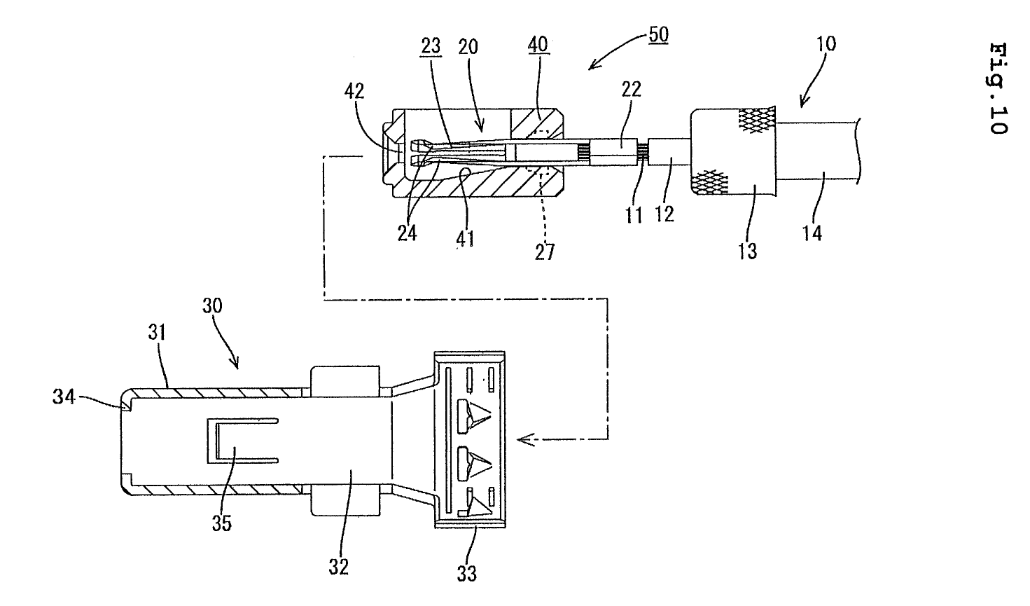

The assembly of the internal terminal 20 and the dielectric 40 is then delivered to the clamping position of an electric wire 10. After the end of the core wire 11 of the shielded electric wire 10 is inserted into the barrel 22 of the internal terminal 20 at the clamping position of an electric wire, the barrel 22 is clamped around the core wire 11 (as if it is wound on the core wire 11), and the internal terminal 20 is cut or separated from the carrier 21 at the same time. Thus, as shown in FIGS. 10 and 11, the internal terminal 20 is clamped on the end of the core wire 11 of the shielded electric wire 10, and the assembly 50 in which the dielectric 40 is fixed on the outer periphery of the internal terminal 20 is formed.

Then, the assembly 50 is delivered to the assembly position with the external terminal 30. As shown in the arrows of FIGS. 10 and 11, the assembly 50 is inserted into the holding part 31 of the external terminal 30 from the rear thereof. The assembly 50 is pushed in while bending and elastically deforming the metal lance 35. When the front face of the dielectric 40 is pushed in until it abuts the frontal stopping pieces 34, the metal lance 35 is restored to its original position before deformation and is secured in the hooking groove 45 of the dielectric 40. Thus, the assembly 50 is held in the external terminal 30 in a condition stopping and preventing slippage thereof. Then, since the folded portion of the net braid wire 13 of the shielded electric wire 10 is positioned inside the barrel 33 of the external terminal 30, the barrel 33 is clamped around the folded portion of the net braid wire 13 (as if it is wound up on the folded portion of the net braid wire 13). Accordingly, as shown in FIG. 14, the assembly of the female shielded terminal S is completed, and may be connected with a corresponding male shielded terminal.

As illustrated above, in the operation of the present invention, when the pair of connecting parts 24 is provided on the internal terminal 20 so as to be brought in contact with the tabs of a corresponding male internal terminal, the rigidity of the fulcrum portion is enhanced and the contact pressure exerted by the connecting parts 24 on the tabs can be enhanced since the connecting parts 24 are formed in L-shaped cantilevered form. The L-shape extends from the side faces to a portion of the lower face of the channel of the connecting parts 23. Accordingly, a highly reliable contact condition can be obtained.

When the connecting pieces 24 of the internal terminal 20 are constructed as described above, there exists the condition in which the connecting parts 24 are externally exposed in the front portion of the internal terminal 20. In the present invention, when the internal terminal 20 is formed, the dielectric 40 is fixed on the internal terminal 20 and the internal terminal 20 is clamped on the end of the core wire 11 of the shielded electric wire 10 to provide the assembly 50. The assembly 50 is then fit in and fixed to the external terminal 30. Therefore, the connecting pieces 24 are protected by the dielectric 40 while the internal terminal 20 is assembled with the external terminal 30, and damage or other adverse conditions to the connecting pieces 24 can be prevented.

The present invention is not limited to the embodiment illustrated according to the description and drawings. For example, the following variation is also included in the technological range of the present invention, and further, various changes other than the following mode of operation can be performed within the scope of the present invention without deviating from the purposes and objects of the present invention.

In an alternative embodiment, the dielectric may be fixed on the internal terminal to provide an assembly, the dielectric and internal terminal assembly may be assembled with the external terminal, and then the core wire and the net braid wire of the shielded electric wire may be simultaneously clamped on the internal terminal and the external terminal, to provide a female shielded terminal S.

Although the invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

The present disclosure relates to subject matter contained in priority Japanese Application No. 2001-000354, filed on Jan. 5, 2001, which disclosure is herein expressly incorporated by reference in its entirety.

What is claimed is:

1. An assembly for a female shielded terminal, said assembly comprising:
an internal terminal connectable to an inner conductor of a shielded electric wire, said internal terminal including at least one elastic connecting piece to contact a corresponding male terminal; and
a dielectric mounted on an outer periphery of said internal terminal to insulate said internal terminal from an external terminal connected to an outer conductor of the shielded electric wire.

2. The assembly for a female shielded terminal according to claim 1,
wherein said at least one elastic connecting piece comprises a pair of elastic connecting pieces provided on said internal terminal, wherein each connecting piece of said pair of connecting pieces is configured in an L-shape extending from a respective facing wall of said internal terminal to a wall of said internal terminal provided between said facing walls, and each connecting piece of said pair of connecting pieces is cantilevered from said internal terminal so that said connecting pieces can elastically sandwich the corresponding male terminal therebetween.

3. The assembly for a female shielded terminal according to claim 2,
wherein said internal terminal further comprises a slit between said connecting pieces and each said connecting piece of said pair of connecting pieces includes a bent portion, wherein said bent portions extend toward each other.

4. The assembly for a female shielded terminal according to claim 1,
wherein said dielectric includes a hole extending from a forward end to a rearward end of said dielectric, said internal terminal being positioned inside said hole.

5. The assembly for a female shielded terminal according to claim 4,
wherein said hole is dimensioned to allow movement of said connecting pieces toward and away from each other.

6. The assembly for a female shielded terminal according to claim 4,
wherein said internal terminal further comprises a pair of thrusting pieces, said thrusting pieces projecting from opposite sides of said internal terminal; and
said dielectric further comprising a pair of pressure grooves extending along sides of said hole to receive said thrusting pieces.

7. The assembly for a female shielded terminal according to claim 1, said assembly further comprising:
an external terminal covering said dielectric and said internal terminal therein;
said external terminal including holding parts positioned at a front portion of said external terminal to receive a front end of said dielectric.

8. The assembly for a female shielded terminal according to claim 7,
wherein said dielectric is block shaped; and
said holding parts form a square for receiving said dielectric.

9. The assembly for a female shielded terminal according to claim 8,
wherein said external terminal further includes a covering wall part positioned rearward of said holding parts, said covering wall part including an open upper face to receive a rear portion of said internal terminal.

10. The assembly for a female shielded terminal according to claim 9,
wherein said external terminal further includes a barrel portion positioned rearward of said covering wall part, said barrel portion including an open upper face to receive a net braid shield of the shielded electric wire and including barrel portions that are bendable to cover the braid shield of the shielded electric wire.

11. The assembly for a female shielded terminal according to claim 7,
wherein said external terminal further includes a lance on a lower face of said external terminal and extending obliquely toward a front portion of said external terminal; and
said dielectric further includes a hooking groove on a lower face of said dielectric and extending from a rearward to a forward direction of said dielectric to receive said lance and secure said dielectric and said external terminal together.

12. A method of assembling a female shielded terminal comprising:
providing an internal terminal to connect to an inner conductor of a shielded electric wire, said internal terminal including at least one elastic connecting piece to contact a corresponding male terminal;
mounting a dielectric on an outer periphery of said internal terminal;
after mounting said dielectric on said internal terminal, connecting said inner conductor of said shielded electric wire to said internal terminal;
providing an external terminal to connect to an outer conductor of said shielded electric wire;
mounting said external terminal on said dielectric and said internal terminal therein; and
after mounting said external terminal on said dielectric and said internal terminal therein, connecting said external terminal to said outer conductor of said shielded electric wire.

13. The method of assembling a female shielded terminal according to claim 12,
wherein said mounting of said dielectric on said internal terminal includes covering said at least one connecting piece with said dielectric so that damage to said at least one elastic connecting piece is prevented.

14. The method of assembling a female shielded terminal according to claim 12, wherein said at least one elastic connecting piece comprises a pair of elastic connecting pieces provided on said internal terminal, wherein each connecting piece of said pair of connecting pieces is configured in an L-shape extending from a respective facing wall of said internal terminal to a wall of said internal terminal provided between said facing walls and each connecting piece of said pair of connecting pieces is cantilevered from said internal terminal so that said connecting pieces can elastically sandwich the corresponding male terminal therebetween;
wherein said mounting of said dielectric on said internal terminal includes covering said pair of elastic connecting pieces with said dielectric so that damage to said pair of elastic connecting pieces is prevented.

15. The method of assembling a female shielded terminal according to claim 12, wherein said dielectric includes a hole extending from a forward end to a rearward end of said dielectric, further comprising:
positioning said internal terminal inside said hole.

16. The method of assembling a female shielded terminal according to claim 15, wherein said internal terminal further comprises a pair of thrusting pieces, said thrusting pieces projecting from opposite sides of said internal terminal, said dielectric further comprising a pair of pressure grooves extending along sides of said hole to receive said thrusting pieces; further comprising:
positioning said thrusting pieces inside said pressure grooves.

17. The method of assembling a female shielded terminal according to claim 12, further comprising:
covering said dielectric and said internal terminal therein with an external terminal, wherein said external terminal includes holding parts positioned at a front portion of said external terminal, and said covering includes receiving a front end of said dielectric with said holding parts.

18. The method of assembling a female shielded terminal according to claim 17, wherein said dielectric is block shaped, and said holding parts form a square for receiving said dielectric, further comprising:
receiving said dielectric with said holding parts so that a forward end of said dielectric abuts said holding parts.

19. The method of assembling a female shielded terminal according to claim 18, wherein said external terminal further includes a covering wall part positioned rearward of said holding parts, said covering wall part including an open upper face to receive a rear portion of said internal terminal, further comprising:
receiving said rear portion of said internal terminal in said covering wall part.

20. The method of assembling a female shielded terminal according to claim 19, wherein said external terminal further includes a barrel portion positioned rearward of said covering wall part, said barrel portion including an open upper face to receive a net braid shield of the shielded electric wire and including barrel portions to bend and cover the braid shield of the shielded electric wire, further comprising:
receiving said net braid shield of said shielded electric wire in said barrel portion; and
bending said barrel portion around said net braid shield to cover said net braid shield.

21. The method of assembling a female shielded terminal according to claim 17, wherein said external terminal further includes a lance on a lower face of said external terminal and extending obliquely toward a front portion of said external terminal and said dielectric further includes a hooking groove on a lower face of said dielectric and extending from a rearward to a forward direction of said dielectric to receive said lance and secure said dielectric and said external terminal together; further comprising:
receiving said lance in said hooking groove, thereby securing said dielectric and said external terminal together.

22. A method of assembling a female shielded terminal comprising:
providing an internal terminal to connect to an inner conductor of a shielded electric wire, said internal terminal including at least one elastic connecting piece to contact a corresponding male terminal;
mounting a dielectric on an outer periphery of said internal terminal;
providing an external terminal to connect to an outer conductor of said shielded electric wire;
mounting said external terminal on said dielectric and said internal terminal therein; and
after mounting said external terminal on said dielectric and said internal terminal therein, simultaneously connecting said inner conductor of said shielded electric wire to said internal terminal and connecting said external terminal to said outer conductor of said shielded electric wire.
